(19) United States
(12) Patent Application Publication
(10) Pub. No.: US 2007/0044895 A1
(43) Pub. Date: Mar. 1, 2007

(54) Web butt-joining apparatus and method

(75) Inventors: Takashi Nawano, Minami-Ashigara-shi (JP); Sanshirou Fukuhara, Minami-Ashigara-shi (JP); Chuzo Kobayashi, Tokyo (JP); Kazuyoshi Suehara, Fujinomiya-shi (JP); Minoru Takahashi, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO.,LTD.

(21) Appl. No.: 11/509,568

(22) Filed: Aug. 25, 2006

(30) Foreign Application Priority Data
Aug. 25, 2005 (JP) 2005-244459

(51) Int. Cl. B32B 37/00

(52) U.S. Cl. 156/157; 156/506; 156/250

(57) ABSTRACT

The present invention provides a web butt-joining apparatus, comprising: a turret device that supports an old roll and a new roll on which band-shaped flexible base materials are wound to be capable of being unwound, and is rotatable at every predetermined angle; a cutting drum including a cutting member and a holding device; a cutting and joining drum which includes a cutting receiving member, and a holding device which is capable of rotating at the same speed as conveyance speed of the band-shaped flexible base material at a time of joining the band-shaped flexible base material; and a joining drum which is capable of rotating at the same speed as the conveyance speed of the band-shaped flexible base material at a time of joining the band-shaped flexible base materials, wherein while conveying the band-shaped flexible base material, the web butt-joining apparatus performs cutting and butt-joining of the tail end of the band-shaped flexible base material of the old roll and the tip end of the band-shaped flexible base material of the new roll.

### BACKGROUND OF THE INVENTION

1. Field of the Invention

The present invention relates to a web butt-joining apparatus and method, and particularly relates to a web butt-joining apparatus and method for joining end portions of a new and an old rolls of thin band-shaped sheet materials (hereinafter, called “web”) of plastic, paper, metal foil and the like in a butted state.

2. Description of the Related Art

In order to join a tail end of an old web and a tip end of a new web in a butted state with high accuracy at the time of joining the webs, the conventional web butt-joining apparatus joins the webs after stopping the line of a coater and a treatment machine having joining apparatuses, or by bringing a web feeding part into a stopping or low-speed state by using an accumulator of the web, namely, by slowing down the web feeding part. However, stopping or slowing down the line each time webs are joined causes the problem of significant reduction in manufacturing efficiency.

When webs are to be joined while being conveyed without stopping or slowing down the line, the web conveyance is performed at a high speed (100 m/minute or higher), and therefore, when the conventional web butt-joining apparatus is to be caused to respond to the high-speed conveyance of the webs, rapid rise in the speed of the new roll is required, and there is the disadvantage of requiring use of a large-sized motor, and occurrence of weaving to the new roll due to abrupt torque.

In order to solve this, the present applicant proposes an apparatus corresponding to increase in the speed of web conveyance (for example, see Japanese Patent Application Laid-Open No. 6-171806).

The web butt-joining apparatus disclosed in Japanese Patent Application Laid-Open No. 6-171806 is a three drum type apparatus including a cutting blade and a member for drawing out a web tip end portion of a new roll, and constituted of a cutting drum capable of rotating at the same speed as the conveyance speed of the web, a cutting and joining drum capable of rotating at the same speed as the conveyance speed of the web, and a joining drum which separably holds the bonding tape and is rotatable at the same speed as the conveyance speed of the web, and is characterized by performing cutting and joining of the web while pinching the tail end of the old roll and the tip end of the new roll with the respective drums, and is described to be capable of solving the above described problem.

### SUMMARY OF THE INVENTION

However, the problems that are not solved in the conventional web butt-joining apparatuses of Japanese Patent Application Laid-Open No. 6-171806 and the like still remain. As the first problem, the construction in which the web is cut by an instant operation by the cutting blade of substantially the same length as the width of the wide web is adopted in the conventional device, and such cutting has the disadvantage of decreasing joining accuracy.

As the second problem, the conventional apparatuses have the disadvantage of causing chips at the time of cutting the webs. The webs of TAC (Triacetyl Cellulose) and the like are easily torn, and easily cause chips of the webs.

As the third problem, in the conventional apparatuses, a replacement operation due to wear and breakage (broken blade) of the cutting blades frequently takes place, and there is the disadvantage of reduction in productivity, increase in cost of consumables and the like.

As the fourth problem, in the conventional apparatuses, the adjusting operation of cutting blades or the like when the thickness, material and the like of the webs change is complicated, and there is the disadvantage of reduction in productivity or the like.

The present invention is made in view of the above circumstances, and has an object to provide a web butt-joining apparatus and method for butt-joining webs capable of joining an old web and a new web, simplifying a mechanism of the apparatus, enhancing joining accuracy and quality, and reducing cost of consumables, cost of the apparatus, and down time.

In order to attain the above-described object, the present invention provides a web butt-joining apparatus, characterized by including a turret device that supports an old roll and a new roll on which band-shaped flexible base materials are wound to be capable of being unwound, and is rotatable at every predetermined angle, a cutting drum including a cutting member, which is provided at a cylindrical portion of a peripheral surface with its tip end protruded, forms an inclined angle of 0.5 degrees to 5 degrees with respect to an axial direction of the cylindrical portion, and has substantially the same length as a width of the band-shaped flexible base material, and a holding device that holds a tip end portion of the band-shaped flexible base material of the new roll, and capable of rotating at the same speed as conveyance speed of the band-shaped flexible base material at a time of joining the band-shaped flexible base materials, a cutting and joining drum which includes a cutting receiving member of substantially the same length as the width of the band-shaped flexible base material, and a holding device which holds a portion in the vicinity of a tail end portion of the band-shaped flexible base material of the old roll, and is capable of rotating at the same speed as conveyance speed of the band-shaped flexible base material at a time of joining the band-shaped flexible base material, and a joining drum which holds a bonding tape to be separable and is capable of rotating at the same speed as the conveyance speed of the band-shaped flexible base material at a time of joining the band-shaped flexible base materials, and characterized in that while conveying the band-shaped flexible base material, the web butt-joining apparatus performs cutting and butt-joining of the tail end of the band-shaped flexible base material of the old roll and the tip end of the band-shaped flexible base material of the new roll.

For this purpose, the present invention provides, in a web butt-joining method for performing cutting and butt-joining of a tail end of a band-shaped flexible base material of an old roll and a tip end of a band-shaped flexible base material wound around a new roll while causing the band-shaped base material wound around the old roll to travel, a web butt-joining method characterized by including the steps of: winding the band-shaped flexible base material of the new roll on a cutting drum, and holding a tip end portion of the band-shaped flexible base material of the new roll by a new web holding device of the cutting drum; winding the band-shaped flexible base material of the old roll on a cutting and joining drum and holding a portion in the vicinity of a tail end portion of the band-shaped flexible base material of the old roll by an old web holding device of the cutting and joining drum; holding a bonding tape at a joining drum; while rotating the cutting and joining drum at the same speed as conveyance speed of the band-shaped flexible base material, and rotating the cutting drum at the same speed as conveyance speed of the band-shaped flexible base material, cutting the band-shaped flexible base material of the old roll and the band-shaped flexible base material of the new roll in an overlapped state by a cutting member which is provided at a cylindrical portion of a peripheral surface of the cutting drum or the cutting and joining drum with its tip end protruded and which forms an inclined angle of 0.5 degrees to 5 degrees with respect to an axial direction of the cylindrical portion; casting away a portion in the vicinity of the tail end portion of the band-shaped flexible base material of the old roll and the tip end portion of the band-shaped flexible base material of the new roll which are cut, and holding the band-shaped flexible base material of the old roll and the band-shaped flexible base material of the new roll on the peripheral surface of the cutting drum or the cutting and joining drum; and bonding the bonding tape held at the joining drum to the band-shaped flexible base material of the old roll and the band-shaped flexible base material of the new roll held at the peripheral surface of the cutting drum or the cutting and joining drum.

According to the present invention, the cutting member is provided to form an inclined angle of 0.5 degrees to 5 degrees with respect to the axial direction of the cylindrical portion, and therefore, the web is cut so that the cut line advances from one end side of the cutting member to the other end side thereof. Accordingly, cutting accuracy is enhanced by such cutting, and the cut end is further fed to the joining drum in sequence from the one end side to the other end side, as a result of which, joining accuracy is enhanced.

In order to attain the above described object, the present invention provides a web butt-joining apparatus characterized by including a turret device that supports an old roll and a new roll on which band-shaped flexible base materials are wound to be capable of being unwound, and is rotatable at every predetermined angle, a cutting drum including a cutting member, which is provided at a cylindrical portion with a radius R of a peripheral surface with its tip end protruded with a protruded amount h, forms an inclined angle θ with respect to a radius direction of the cylindrical portion, and has substantially the same length as a width of the band-shaped flexible base material, a cushioning member composed of foaming rubber provided at both sides of the cutting member, and a holding device that holds a tip end portion of the band-shaped flexible base material of the new roll, with the inclined angle θ in the relationship of 20 degrees≧θ≧cos⁻¹(R/(R+h)), and capable of rotating at the same speed as conveyance speed of the band-shaped flexible base material at a time of joining the band-shaped flexible base materials, a cutting and joining drum which includes a cutting receiving member of substantially the same length as the width of the band-shaped flexible base material, and a holding device which holds a portion in the vicinity of a tail end portion of the band-shaped flexible base material of the old roll, and is capable of rotating at the same speed as conveyance speed of the band-shaped flexible base material at a time of joining the band-shaped flexible base materials, and a joining drum which holds a bonding tape to be separable and is capable of rotating at the same speed of the conveyance speed of the band-shaped flexible base material at a time of joining the band-shaped flexible base materials, and characterized in that while transferring the band-shaped flexible base material, the web butt-joining apparatus performs cutting and butt-joining of the tail end of the band-shaped flexible base material of the old roll and the tip end of the band-shaped flexible base material of the new roll.

For this purpose, the present invention provides, in a web butt-joining method for performing cutting and butt-joining of a tail end of a band-shaped flexible base material of an old roll and a tip end of a band-shaped flexible base material wound around a new roll while causing the band-shaped base material wound around the old roll, a web butt-joining method including the steps of: winding the band-shaped flexible base material of the new roll on a cutting drum, and holding a tip end portion of the band-shaped flexible base material of the new roll by a new web holding device of the cutting drum; winding the band-shaped flexible base material of the old roll on a cutting and joining drum and holding a portion in the vicinity of a tail end portion of the band-shaped flexible base material of the old roll by an old web holding device of the cutting and joining drum; holding a bonding tape at a joining drum; while rotating the cutting and joining drum at the same speed as conveyance speed of the band-shaped flexible base material, and rotating the cutting drum at the same speed as conveyance speed of the band-shaped flexible base material, cutting the band-shaped flexible base material of the old roll and the band-shaped flexible base material of the new roll in an overlapped state by a cutting member which is provided at a cylindrical portion with a radius R of a peripheral surface of the cutting drum or the cutting and joining drum with its tip end protruded with a protruded amount h and which forms an inclined angle 0 with respect to a radius direction of the cylindrical portion, which is a cutting member with the inclined angle θ being in relationship of 20 degrees≧θ≧cos⁻¹(R/(R+h)), and cushioning members composed of foaming rubber provided at both sides of the cutting member; casting away a portion in the vicinity of the tail end portion of the band-shaped flexible base material of the old roll and the tip end portion of the band-shaped flexible base material of the new roll which are cut, and holding the band-shaped flexible base material of the old roll and the band-shaped flexible base material of the new roll on the peripheral surface of the cutting drum or the cutting and joining drum; and bonding the bonding tape held at the joining drum to the band-shaped flexible base material of the old roll and the band-shaped flexible base material of the new roll held at the peripheral surface of the cutting drum or the cutting and joining drum.

According to the present invention, the old web and the new web are cut in the state in which one is overlaid on the other by the cutting member of which tip end is projectingly provided at the cylindrical portion of the peripheral surface of the cutting drum or the cutting and joining drum, and which forms the inclined angle θ in the relationship of 20 degrees≧θ≧cos⁻¹(R/(R+h)) with respect to the radius direction of the cylindrical portion, and the cushioning members composed of a foaming rubber which are provided at both sides of the cutting member, and therefore the disadvantage of causing chips at the time of cutting the webs can be significantly eliminated.

Namely, the cutting member forms the inclined angle θ in the relationship of 20 degrees≧θ≧cos⁻¹(R/(R+h)), and the cushioning members composed of a foaming rubber which are provided at both sides of the cutting member. Therefore, the cutting member bends to form inclination further, the web held by the cushioning members also deforms in the optimum shape, and it can be made difficult to cause chips at the time of cutting the web. The details will be described later.

In order to attain the above described object, the present invention provides a web butt-joining apparatus, including a turret device that supports an old roll and a new roll on which a band-shaped flexible base materials are wound to be capable of being unwound, and is rotatable at every predetermined angle, a cutting drum including a cutting member block, which is provided at a front surface of a block with its tip end protruded, with a cutting member of substantially the same length as the width of the band-shaped flexible base material embedded therein, a cylindrical portion having a peripheral surface capable of fitting the cutting member block in a recessed portion formed on a front surface to be flush with each other, and a holding device holding a tip end portion of the band-shaped flexible base material of the new roll, and capable of rotating at the same speed as conveyance speed of the band-shaped flexible base material at a time of joining the band-shaped flexible base materials, a cutting and joining drum which includes a cutting receiving member of substantially the same length as the width of the band-shaped flexible base material, and a holding device which holds a portion in the vicinity of a tail end portion of the band-shaped flexible base material of the old roll, and is capable of rotating at the same speed as conveyance speed of the band-shaped flexible base material at a time of joining the band-shaped flexible base materials, and a joining drum which holds a bonding tape to be separable and is capable of rotating at the same speed as the conveyance speed of the band-shaped flexible base material at a time of joining the band-shaped flexible base materials, and characterized in that while transferring the band-shaped flexible base material, the web butt-joining apparatus performs cutting and butt-joining of the tail end of the band-shaped flexible base material of the old roll and the tip end of the band-shaped flexible base material of the new roll.

According to the present invention, the cutting member provided at the cutting drum is embedded in the block, and the cutting member block is capable of being fitted in the recessed portion formed in the cylindrical portion of the cutting drum surface to be flush with the recessed portion. Accordingly, replacement of the cutting member and fine adjustment of the cutting blade position and the like can be performed by only replacing the cutting member block, the mechanism of the apparatus can be simplified, joining accuracy and quality can be enhanced, and downtime can be reduced.

In the present invention, it is preferable that Vickers hardness of the cutting receiving member is 1000 or more. When the cutting receiving member on which the cutting blade of the cutting member abuts is hard, and the Vickers hardness is 1000 or more in particular, the trouble of the cutting edge biting the cutting receiving member hardly occurs, and the disadvantage of causing chips when cutting the old web and the new web in the state in which one is overlaid on the other can be significantly reduced.

In the present invention, it is preferable that a metallizing plating layer of a thickness of 10 to 30 μm is formed on a front surface of the cutting receiving member. With the metallizing plating layer of such a thickness, the disadvantage of the metallizing plating layer curling up and being damaged can be reduced, and the useful life of the cutting receiving member can be significantly extended.

In the present invention, it is preferable that Vickers hardness of the cutting member is 600 to 1000.

When the hardness of the cutting member is lower than the hardness of the cutting receiving member like this, damage to the cutting receiving member is small, and the useful life of the cutting receiving member can be significantly extended.

As described thus far, according to the present invention, joining accuracy can be enhanced.

### BRIEF DESCRIPTION OF THE DRAWINGS

FIG. 1 is a schematic view of a web butt-joining apparatus of the present invention;

FIG. 2 is a schematic view of an essential part of a joining unit;

FIG. 3 is a structural view of a removing unit which removes a cut remaining portion of an old roll;

FIG. 4 is a schematic view of an essential part of a cutting drum of the joining unit;

FIGS. 5A and SB are plane views and the like showing a butting state of webs;

FIG. 6 is a state view showing a state directly before joining;

FIG. 7 is an explanatory view explaining drawing-out of a new roll tip end portion;

FIG. 8 is a graph explaining the drawing-out of the new roll tip end portion;

FIG. 9 is an enlarged view of an essential part explaining cutting of the web;

FIG. 10 is an enlarged view of an essential part explaining joining of the web;

FIG. 11 is a schematic view of an essential part of a cutting drum of a joining unit of a second embodiment;

FIG. 12 is a table showing a result of example 1; and

FIG. 13 is a table showing a result of example 2.

### DETAILED DESCRIPTION OF THE PREFERRED EMBODIMENTS

Hereinafter, a preferred embodiment (first embodiment) of a web butt-welding apparatus and method according to the present invention will be described in detail with reference to the attached drawings.

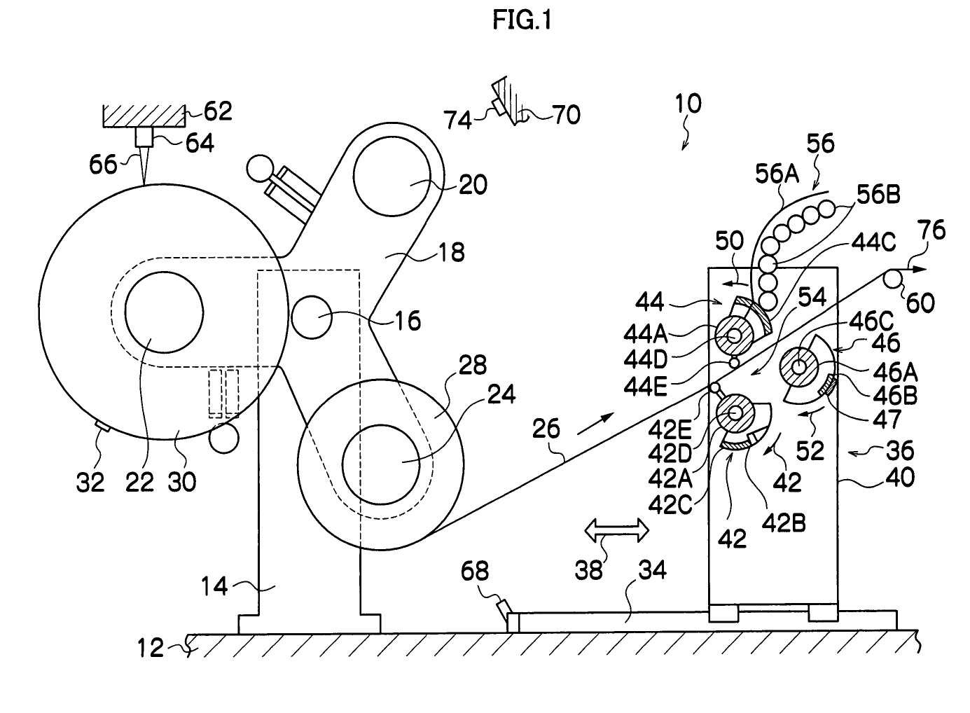

FIG. 1 is a schematic view of a web butt-joining apparatus 10 according to the present invention. In the web butt-joining device 10, a support column 14 is vertically provided on a base stand 12, a trifurcated turret arm 18 is rotatably supported at a turret shaft 16 at a tip end portion of the support column 14. The turret arm 18 can rotate intermittently at every 120 degrees around the turret shaft 16.

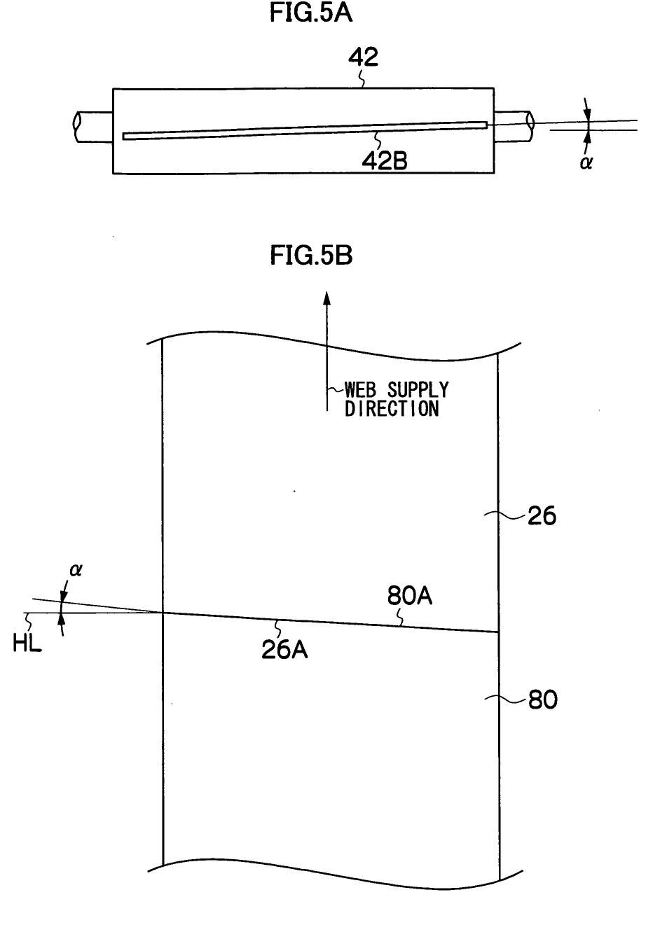

Roll shafts 20, 22 and 24 are rotatably supported at the respective tip end portions of the turret arm 18, and an old roll 28 on which an old web 26 under conveyance is wound and a new roll 30 on which a new web 80 (see FIGS. 5A and SB, 9 and 10) is wound are pivotally supported respectively on the two roll shafts 22 and 24 among these roll shafts 20, 22 and 24 to be capable of being unwound.

On the remaining unused roll shaft 20, a new roll which is used next to the new roll 30 is pivotally supported. Each of the roll shafts 20, 22 and 24 is connected to a rotary drive source not shown, so that the new roll 30 can be rotated at the same speed as the conveyance speed of the old web 26 at the time of joining the new and old webs that will be described later. A tip end portion of the new roll 30 is temporarily bonded to web source winding so that a tip end portion of a new web 80 is not detached from the web source winding while the new roll 30 is rotating, and a tip end mark 32 is attached to the tip end portion of the new roll 30.

A guide rail 34 is laid on the base stand 12 along a conveyance direction of the web, and a joining unit 36 is provided to be travelable on-the guide rail 34. Thereby, the joining unit 36 is capable of advancing to and retreating from the turret arm 18 in the direction of the arrow 38 in the drawing.

In a casing 40 of the joining unit 36, a cutting drum 42, a cutting and joining drum 44 and a joining drum 46 are rotatably supported at respective rotary shafts 42A, 44A and 46A. The respective rotary shafts 42A, 44A and 46A are connected to the rotary drive source not shown, so that the cutting drum 42, the cutting and joining drum 44 and the joining drum 46 can be rotated in the directions of the arrows 48, 50 and 52 in the drawing at the same speed as the conveyance speed of the old web 26 at the time of joining the webs.

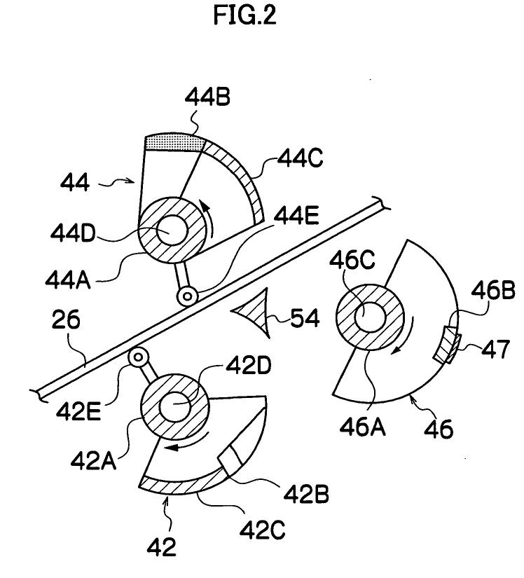

As shown in FIG. 2, in the cutting drum 42, its outer peripheral portion is formed of an elastic material such as rubber, a cutter 42B is included in a substantially center of the outer peripheral portion, a suction pad 42C is formed at the outer peripheral portion of a front side in a rotating direction and is connected to a suction device not shown via a hollow shaft portion 42D. The detail of a peripheral portion of the cutter 42B will be described later.

The cutting and joining drum 44 has an abutting plate 44B which is a cutting receiving member at a front side in the rotating direction of its outer peripheral portion, and a shearing force works as a result that the abutting plate 44B and the cutter 42B of the cutting drum 42 abut on each other to be able to cut the webs (the old web 26, the new web 80). A suction pad 44C is formed on the outer peripheral portion of the rear side in the rotating direction of the cutting and joining drum 44, and is connected to a suction device not shown via a hollow shaft portion 44D.

The joining drum 46 has a suction pad 46B, which separably sucks a back surface of a bonding tape 47 in a substantially center of its outer peripheral portion, and which is connected to a suction device not shown via a hollow shaft portion 46C. Guide rollers 42E and 44E are mounted to the cutting drum 42 and the cutting and joining drum 44 so as to support the web (old web 26) between the old roll 28 and a pass roller 60.

A guide member 54 with a triangular section which guides the webs (the old web 26, the new web 80) at the time of joining so as not to deviate from a web conveyance route is provided in a substantially triangular space portion surrounded by the rotational outer periphery of each of the drums 42, 44 and 46. The guide member 54 is mounted to a casing 40 (see FIG. 1).

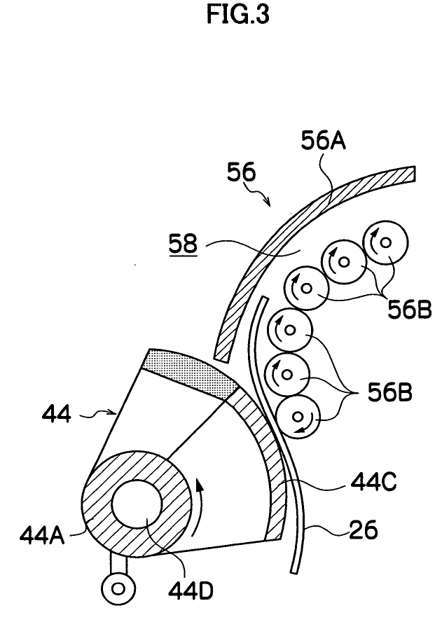

As shown in FIG. 3, a removing unit 56 for removing a remaining portion of the old web 26 which is cut at the time of joining from the web conveyance route is provided in the vicinity of the area above the cutting and joining drum 44. In the removing unit 56, a plurality of revolving rollers 56B, 56B are rotatably arranged with a slightly larger space than the thickness of the web along an arc-shaped guide plate 56A to form a removing passage 58 in a space from a guide plate 56A.

A plurality of revolving rollers 56B, 56B are connected to a rotary driving source not shown, so as to rotate in the direction opposite from the rotating direction of the cutting and joining drum 44, and at a higher circumferential speed than the rotation (circumferential speed) of the cutting and joining drum 44. Thereby, the remaining portion of the old web 26 which is cut, and sucked and held by the suction pad 44C of the cutting and joining drum 44 is pinched by the cutting and joining drum 44 and the plurality of revolving rollers 56B, 56B, raised up to the removing passage 58, and is removed from the conveyance route of the web.

As shown in FIG. 1, a roll outside diameter sensor 64 which measures an outside diameter of the new roll 30 is mounted to a wall surface 62 located above the new roll 30. The outside diameter of the new roll 30 can be measured by measuring the distance up to the outer periphery of the new roll 30 by causing light beam 66 from the roll outside diameter sensor 64 to reflect at the outer peripheral surface of the new roll 30.

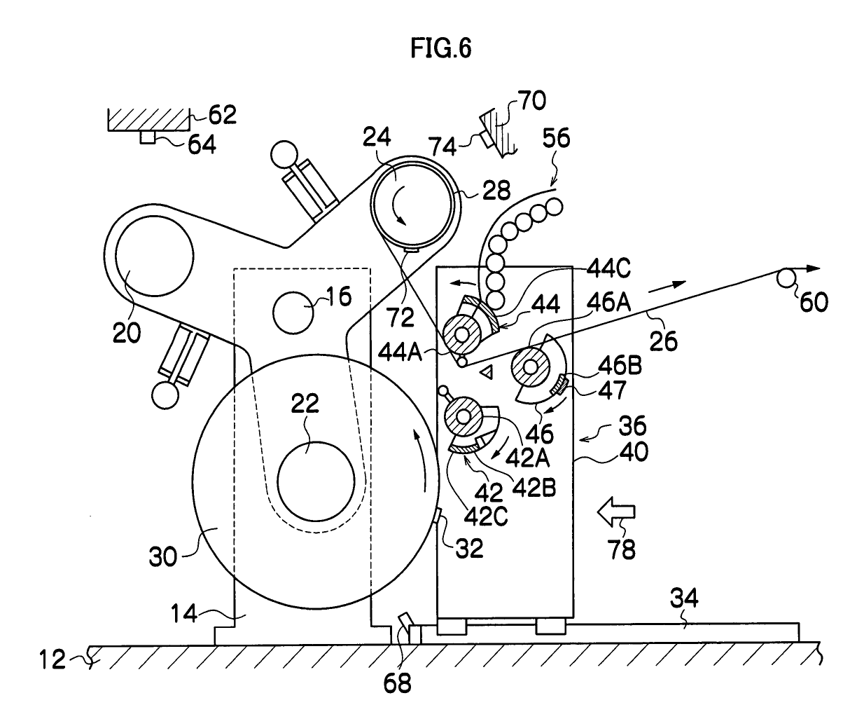

A tip end mark sensor 68 is provided at a tip end portion of the guide rail 34 at the turret arm 18 side. The tip end mark sensor 68 is adapted to detect the tip end mark 32 of the new roll 30 when the turret arm 18 rotates 120 degrees and the new roll 30 moves to the position in FIG. 6 at the time of joining the webs.

A tail end mark sensor 74 which detects a tail end mark 72 attached to a tail end portion of the old roll 28 is mounted to a wall surface 70 above the old roll 28 that moves to the position shown in FIG. 6. The signals of these sensors 64, 68 and 74 are inputted into a controller not shown so as to control the moving distance of the joining unit 36 and the rotation timing of the respective drums 42, 44 and 46.

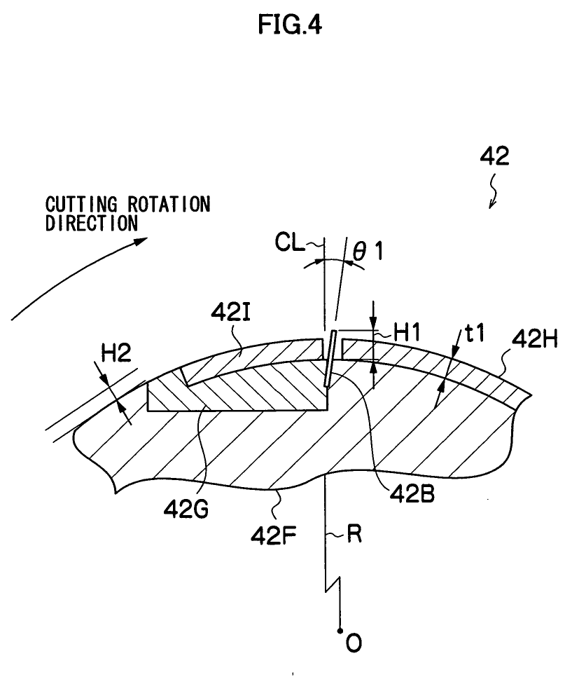

Next, the detail of the peripheral portion of the cutter 42B in the cutting drum 42 will be described. FIG. 4 is a sectional view of an essential part of the cutting drum 42. In the peripheral portion of the cutter 42B in the cutting drum 42, a cutting drum main body 42F and an insert 42G, which is fitted into a recessed portion formed on the surface of the cutting drum main body 42F, form a cylindrical portion of the peripheral surface.

The cutter 42B is provided at the cylindrical portion with its tip end protruded, and is fixed to form an inclined angle θ1 with respect to the direction of a radius CL of the cylindrical portion. The inclined angle θ1 is in the relationship of 20 degrees≧θ1≧cos⁻¹(R/(R+H2)) when the radius of the peripheral surface is set as R and the protruded amount of the tip end of the cutter 32B is set as H1.

Fixing of the cutter 42B is achieved by sandwiching the cutter 42B by the cutting drum main body 42F and the insert 42G. The cutting drum main body 42F and the insert 42G at both sides of the cutter 42B are flush with each other.

Cushioning members 42H and 42I formed of foaming rubber are provided at both sides of the cutter 42B. The cushioning members 42H and 42I preferably have hardness of 50 or less in the hardness defined in JIS K 6301.

A protruded amount HI of the cutter 42B from the surfaces of the cutting drum main body 42F and the insert 42G is preferably in the range of 3 to 5 mm. A protruded amount H2 of the cutter 42B from the circumferential surface of the cutting drum main body 42F is preferably in the range of the thickness of the webs (the total thickness of the old web 26 and the new web 80) plus 0.05 to 0.1 mm.

Next, the disposition of the cutter 42B in the width direction of the cutting drum 42 will be described. FIGS. 5A and SB are views explaining the relationship, FIG. 5A is a plane view of the cutting drum 42, and FIG. 5B is a plane view showing a butting state of the webs. In FIG. SA, the cushioning members 42H and 42I, and the like are not shown.

As shown in FIG. 5A, the cutter 42B forms an inclined angle α of 0.5 to 5 degrees with respect to the axial direction of the cutting drum 42. Thereby, as shown in FIG. 5B, butt-joining is performed so that the joining line of the webs (the end portion 26A of the old web 26, the end portion 80A of the new web 80) after butt-joining forms an inclined angle α of 0.5 to 5 degrees with respect to a vertical line HL relative to the supplying direction of the web.

Next, the cutter 42B will be described. The Vickers hardness Hv of the cutter 42B is preferably 600 to 1000, and Hv is more preferably 750 to 800. If the hardness Hv of the cutter 42B is lower than the Vickers hardness Hv (that will be described later) of the abutting plate 44B (see FIG. 2 already described) like this, the abutting plate 44B is less damaged, and the useful life of the abutting plate 44B can be remarkably extended.

The Vickers hardness Hv of the abutting plate 44B which is the cutting receiving member is preferably 1000 or higher. If the abutting plate 44B on which the cutting edge of the cutter 42B abuts is hard, and especially has the Vickers hardness Hv of 1000 or higher like this, the problem that the cutting edge of the cutter 42B bites into the abutting plate 44B hardly occurs, and the disadvantage of causing chips when cutting the old web 26 and the new web 80 in the overlaid state can be solved. As the material of the abutting plate 44B, the material enhanced in the quenching hardness by quenching of the nitride steel, and carbonizing can be preferably adopted.

A metallizing plating layer of a thickness of 10 to 30 μm is preferably formed on the surface of the abutting plate 44B. With the metallizing plating layer of such a thickness, the disadvantage of the metallizing plating layer curling up, and being damaged can be eliminated, and the useful life of the abutting plate 44B can be remarkably extended. For this metallizing plating layer, hard chromium metallizing plating can be preferably adopted.

As already described, the cutter 42B forms an inclined angle 01 with respect to the radius CL direction of the cylindrical portion and is fixed. The cutter 42B is fixed in an open sided state with the inclined angle 9 1 formed with respect to the radius CL direction like this. Therefore, when cutting is started by causing a crack to the web on the occasion of abutting on the web, the locus of the cutting edge after the tip end of the cutter 42B abuts on the web until it further abuts on the cutting and joining drum 44, and the direction of the crack at the time of start of the cutting substantially coincide with each other by having the inclined angle 01, and beautiful cutting is performed without fluff on the cutting surface.

Since the cushioning members 42H and 42I with proper hardness are provided at both sides of the cutter 42B, the cutter 42B is held more firmly by the cushioning members 42H and 42I, but it does not cause the compression stress to the inside of the web by compression deformation, and therefore, the web has no cutting strain, thus making it difficult to cause chips at the time of cutting the web.

On this occasion, it is important that the inclined angle θ1 of the cutter 42B inclines to the rotating direction side (forms the inclined angle θ1 to the right side with respect to the radius CL direction) as shown in FIG. 4.

Next, an operation of the web butt-joining apparatus 10 of the present invention constructed as above will be described. As shown in FIG. 1, the old web 26 which is unwound from the old roll 28 is conveyed in the direction of the arrow 76 in the drawing through the space between the cutting and joining drum 44 and the cutting drum 42, and the joining drum 46 while being supported by the pass roller 60, and is fed to a coating process step and a treatment process step not shown. At this time, in order to prevent warp of the old web 26, the intermediate portion of the old web 26 is supported with the guide rollers 42E and 44E of the cutting drum 42 and the cutting and joining drum 44.

While the old web 26 is unwound in the state in FIG. 1, the outside diameter dimension of the new roll 30 is measured by the roll outside diameter sensor 64, and its signal is inputted into the aforementioned controller not shown. When the outside diameter dimension of the new roll is measured, the turret arm 18 rotates 120 degrees to move the old roll 28 and the new roll 30 to the position shown in FIG. 6, the joining unit 36 moves on the guide rail 34 in the direction of the arrow 78 in the drawing based on the moving distance determined from the outside diameter dimension of the new roll inputted into the controller, and stops at the position close to the outer peripheral surface of the new roll 30.

Next, the tail end mark sensor 74 detects the tail end mark 72 attached to the old roll 28, and the signal which informs that the web amount of the old roll 28 is the predetermined amount or less is inputted into the controller. The controller gives an instruction to the driving source which drives the rotary shaft 22 of the new roll 30 to rotate the new roll 30 counterclockwise, and accelerates the new roll 30 to the same speed as the conveyance speed of the old web 26 (for example, 100 m/minute or higher).

Next, when the tip end mark detector 68 detects the tip end mark 32 of the new roll 30, and the signal is inputted into the controller, the controller gives an instruction to the rotary drive source which rotates the rotary shafts 42A, 44A and 46A of the respective drums-42, 44 and 46 to rotate the respective drums 42, 44 and 46 at the same speed as the conveyance speed of the old web 26, and the suction pads 42C, 44C and 46B of the respective drums 42, 44 and 46 in the suction state.

At this time, the cutting drum 42 starts rotation in a timing at which its speed becomes the same as the conveyance speed of the old web 26 at the drawing-out position for drawing out the tip end portion of the new roll 30, and draws the tip end portion of the new roll 30 by sucking it with the suction pad 42C of the cutting drum 42.

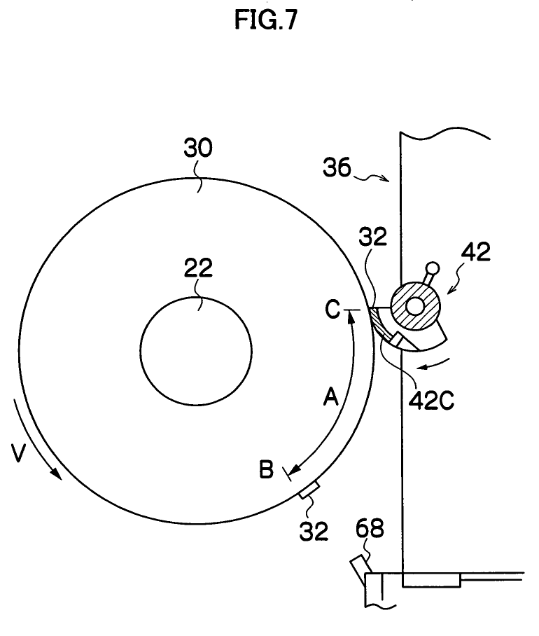

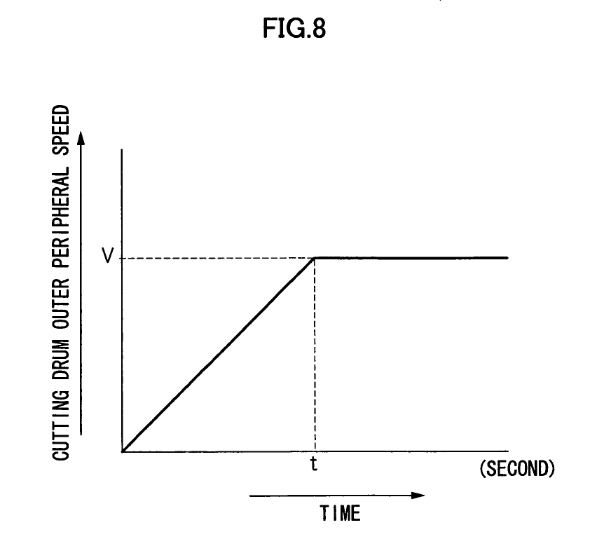

Namely, as shown in FIG. 7, when the outer peripheral speed of the new roll 30 is set as V, and the time in which the new roll 30 moves a distance A from the tip end portion detecting position B to the above described drawing-out position C is set as t seconds, the cutting drum 42 is rotationally driven in a timing at which its speed becomes equal to the outer peripheral speed V of the new roll 30 t seconds later from the start of rotation as shown in the graph of FIG. 8.

Thereby, the web tip end portion of the new roll 30 can be reliably drawn out with the suction pad 42C of the cutting drum 42. Similarly, the cutting and joining drum 44 and the cutting drum 42 are also started to rotate in a timing of cutting and joining of the web that will be described later.

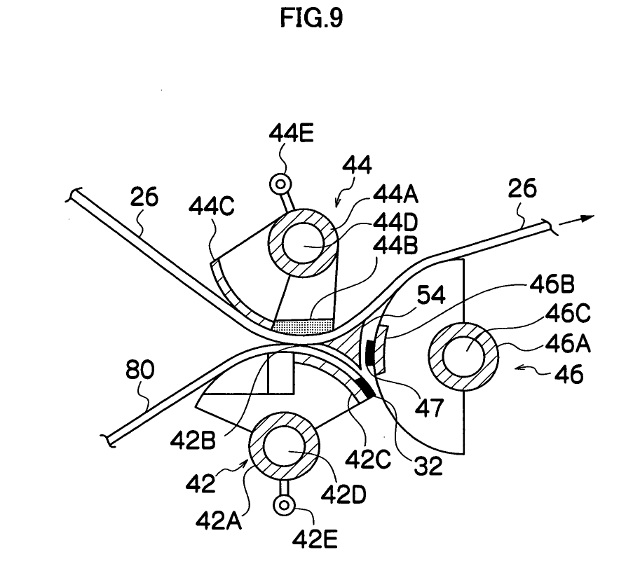

When the cutting drum 42 and the cutting and joining drum 44 rotate to the angles in the state shown in FIG. 9, the cutting drum 42 and the cutting and joining drum 44 pinch the old web 26 and the new web 80 with the old web 26 overlaid on the new web 80, and the cutter 42B of the cutting drum 42 and the abutting plate 44B of the cutting and joining drum 44 cut the old and new webs 26 and 80.

Since the cutter 42B is fixed in an open-sided state, forming the inclined angle θ1 with respect to the radius CL direction, it provides a proper warp amount in the traveling direction in which the web is cut when it abuts on the webs (overlapping body of the old web 26 and the new web 80). Since the cushioning members 42H and 421 with proper hardness are provided at both sides of the cutter 42B, the cutter 42B is firmly held by the cushioning members 42H and 42I, but they do not apply compression deformation to the web. Therefore, there is no compression strain, and strain is not applied to the web under cutting, thus making it difficult to cause chips at the time of cutting the webs.

As shown in FIG. 5A which is already described, the cutter 42B is provided to form an inclined angle α of 0.5 to 5 degrees with respect to the axial direction of the cylindrical portion, and therefore, the web is cut so that the cutting line advances from one end side of the cutter 42B to the other end side. Therefore, cutting accuracy is enhanced by such cutting, and the web is smoothly fed in sequence to the joining drum 46 from the one end which is cut, as a result of which, the joining accuracy is enhanced.

In FIG. 9, on cutting, the web tip end portion after cutting of the new web 80 is quickly taken into a gap between the cutting drum 42 and the cutting and joining drum 44 which rotate in the reverse directions from each other and while being pinched by them, it is guided by the guide member 54 and moves in the transfer direction. Further, the tip end of the new web 80 is fed out to the tip end portion side by the rotation of the new roll 30, and therefore, it does not deviate from the cut portion.

Meanwhile, the tail end of the old web 26 after cutting moves in the conveyance direction of the web while being pinched by the cutting and joining drum 44 and the joining drum 46. Thereby, the tail end of the old web 26 after cutting and the tip end of the new web 80 after cutting are reliably conveyed to the joining position in the butted state.

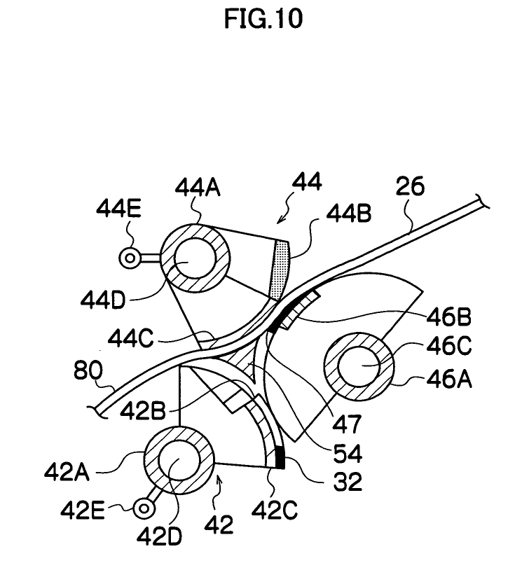

Next, when the respective drums 42, 44 and 46 rotate to the angle shown in FIG. 10, while the old and new webs 26 and 80 are pinched with the cutting and joining drum 44 and the joining drum 46, the butting portions of the old and new rolls 26 and 80 are joined by the bonding tape 47 suction-held by the suction pad 46B of the joining drum 46.

Then, the respective drums 42, 44 and 46 which finish joining rotate to the original position and stop, and the suction state of the suction pads 42B, 44B and 46B of the respective drums 42, 44 and 46 is released. The joining unit 36 moves on the guide rail 34 to retreat to the original position, and conveyance of the web of the new roll 30 is started in the state in FIG. 1 again.

While the cut remaining portion of the old web 26 which is cut at the time of cutting is removed from the transfer route by the removing unit 56 shown in FIG. 3, the cut remaining portion of the new web 80 is suction-held by the suction pad 42B of the cutting drum 42 to move to the stop position of the cutting drum 42, and by releasing suction of the suction pad 42B, it falls from the cutting drum 42 with self-weight. From the above, butt-joining of the old and new webs 26 and 80 is completed.

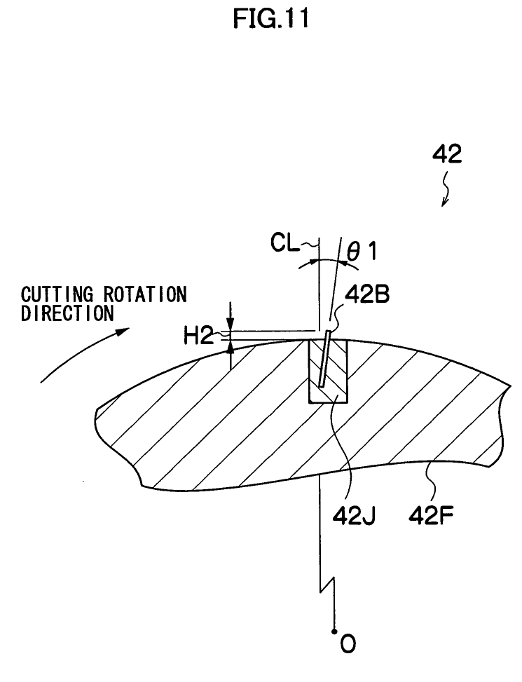

Next, in accordance with FIG. 11, a second embodiment of the web butt-joining apparatus of the present invention will be described. The same members as in the first embodiment already described will be explained by giving the same reference numerals and characters.

As shown in FIG. 11 (corresponding to FIG. 4 of the first embodiment), in the cutting drum 42, a cutting member block 42J is fitted into the recessed portion formed on surface of the cutting drum main body 42F to form the cylindrical portion of the peripheral surface of the cutting drum 42 so that the surface of the cutting member block 42J and the surface of the cutting drum main body 42F are flush with each other.

A tip end of the cutter 42B is provided to protrude from the surface of the cutting member block 42J. A protruded amount H2 of the cutter 42B from the surface of the cutting member block 42J is set substantially similarly to the H2 of the first embodiment. In this embodiment, cushioning members are not provided at both sides of the tip end portion of the cutter 42B, but the cushioning members may be provided as in the first embodiment.

The material of the cutter 42B (Vickers hardness Hv, and the like), the inclined angle θ1 with respect to the direction of the radius CL of the cylindrical portion of the cutter 42B, the inclined angle a of the cutter 42B with respect to the axial direction of the cutting drum 42, and the like are set substantially similarly to the first embodiment.

As for the method for fixing the cutting member block 42J to the cutting drum main body 42F, various known methods such as fixing by the screw member not shown and shrinkage fitting utilizing thermal expansion can be adopted.

Since according to this embodiment, the cutter 42B provided at the cutting drum 42 is embedded into the cutting member block 42J, and the cutting member block 42J is capable of being fitted into the recessed portion formed in the cylindrical portion of the surface of the cutting drum main body 42F to be flush with each other, replacement of the cutter 42B and fine adjustment of the cutting blade position or the like can be performed by only replacing the cutting member block 42J, the mechanism of the device can be simplified, joining accuracy and quality can be enhanced, and downtime can be reduced.

Namely, by, adopting the mode in which a plurality of cutting member blocks 42J with the protruded amount H2, the inclined angle θ1, the inclined angle α that are already described and the like changed are prepared and the cutting member block 42J is replaced with the optimum cutting member block 42J in accordance with the thickness and quality of the web, joining accuracy and quality can be enhanced and downtime can be reduced.

As above, according to the web butt-joining apparatus 10 of the present invention, the first problem of the disadvantage of poor joining accuracy of cutting by the conventional devices, the second problem of the disadvantage of occurrence of chips at a time of cutting webs in cutting by the conventional devices, the third problem of the disadvantage of reduction in productivity, increase in consumables cost and the like in cutting by the conventional devices, and the fourth problem of the disadvantage of reduction in productivity and the like in cutting by the conventional devices are all solved.

The web butt-joining apparatus 10 of the present invention brings the joining unit 36 close to the outer periphery of the new roll 30 based on the signal of the roll outside diameter sensor 64 which detects the outside diameter of the new roll 30, rotates the new roll 30 at the same speed as the conveyance speed of the old web 26, draws out the tip end portion of the new roll 30 with the suction pad 42C of the cutting drum 42 of the joining unit 36, and buts and joins the end portions of the old and new webs 26 and 80 in corporation with the cutting drum 42, the cutting and joining drum 44 and the joining drum.

Thereby, joining can be performed without decreasing the unwinding speed of the old web 26 at the time of joining, and therefore, an accumulator becomes useless. It is not necessary to stop or slow down the operation of the line at the time of joining, and therefore, production efficiency can be enhanced.

Since the joining unit 36 is provided to be capable of advancing and retreating, and the tip end portion of the rotating new roll 30 is directly drawn out with the cutting drum 42, the tip end portion of the new roll does not have to be conveyed to the joining unit. Since thereby, the joining mechanism can be simplified, joining accuracy can be enhanced and the device cost can be reduced.

The examples of the embodiments of the web butt-welding apparatus and method according to the present invention are described thus far, but the present invention is not limited to the examples of the above described embodiments, and various modes can be adopted.

For example, in the examples of the embodiments, the three-drum construction with the cutting drum 42, the cutting and joining drum 44 and the joining drum 46 is adopted, but a four-drum construction with the cutting drum 42, the cutting and joining drum 44, the joining drum 46 and a nip drum can be adopted. In this case, the cutting and joining drum 44 is not used for butt-joining of webs, but the joining drum 46 and the nip drum disposed to be opposed to this perform butt-joining.

The construction of the web butt-joining apparatus is not limited to the examples of these embodiments, and the constructions as in, for example, the apparatus disclosed in Japanese Examined Application Publication No. 6-57579 and the apparatus disclosed in Japanese Patent No. 3584456 can be adopted.

### EXAMPLES

### Example 1

Butt-joining of the webs was performed by using the web butt-joining apparatus 10 shown in FIG. 1. The diameter of the cutting drum 42 was 300 mm (the radius R was 150 mm). The protruded amount of the tip end of the cutter 42B shown in FIG. 4 was 0.25 mm, and the inclined angle θ1 was 5 degrees.

For the web, TAC (Triacetyl Cellulose) of a width of 1400 mm and a thickness of 100 μm was used. The conveyance speed of the web was 100 m/minute.

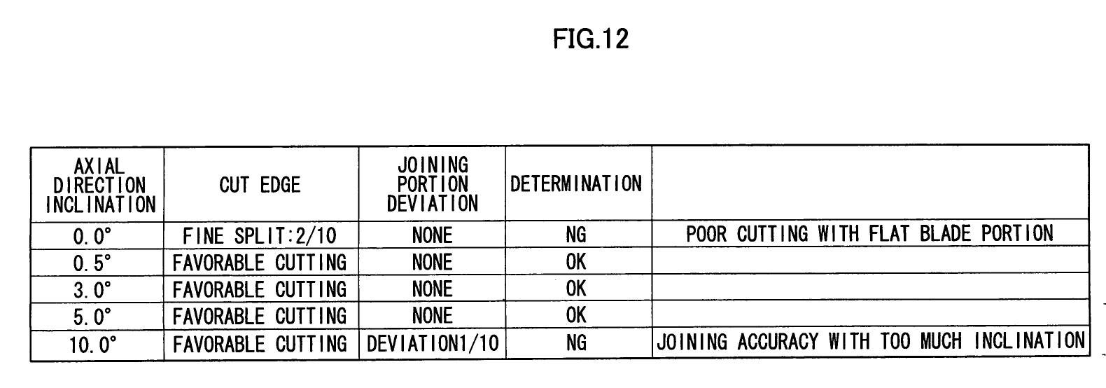

The inclined angle α shown in FIGS. 5A and 5B was changed from 0 to 10 degrees under the 5 conditions, the cut edge state of the web and the joined portion deviation was visually evaluated. The butt-joining test of the webs was repeated ten times under the same conditions. The result is shown in the table in FIG. 12.

According to the table in FIG. 12, when the inclined angle α is in the range of 0.5 to 5 degrees, each of the cut edge states of the webs is favorable, the joined portion deviations are favorable, and the judgment is OK for all. On the other hand, in the test of 0 degrees in which the inclined angle a was less than 0.5 degrees, fine splits occurred to the two cases in the cut edge state of the web, and judgment was NG. Namely, it has been confirmed that the cutter without the inclined angle α, performs poor cutting.

In the test of 10 degrees in which the inclined angle α exceeds 5 degrees, deviation occurred to one case in the joined portion deviation, and the judgment was NG. Namely, it has been confirmed that when the inclined angle a is too large, the joining accuracy becomes worse.

### Example 2

Butt-joining of the webs was performed by using the web butt-joining apparatus 10 shown in FIG. 1. The diameter of the cutting drum 42 is under the two conditions of 250 mm and 300 mm (the radius R is under the two conditions of 125 mm and 150 mm). The inclined angle a shown in FIGS. 5A and 5B was 1 degree.

For the web, TAC (Triacetyl Cellulose) of a width of 1400 mm and a thickness of 100 μm was used. The conveyance speed of the web was 100 m/minute.

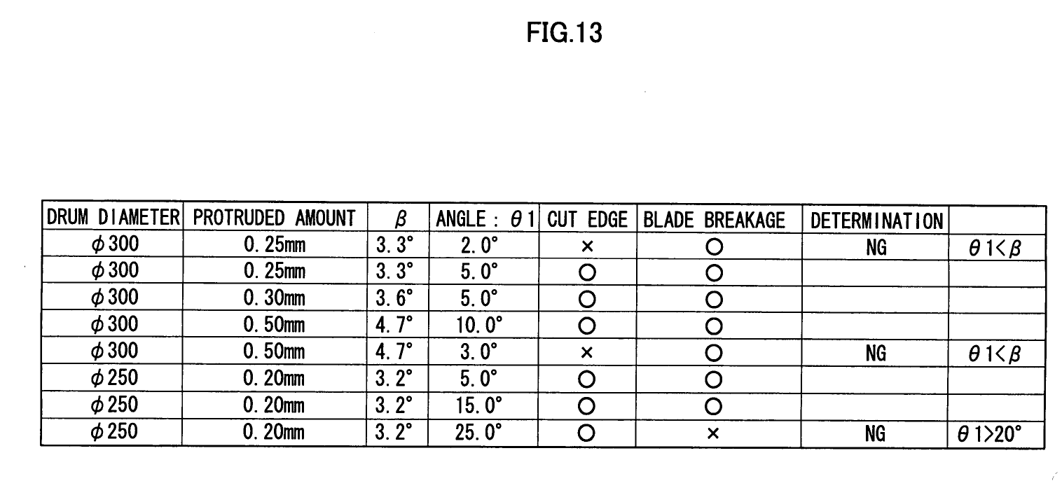

The protruded amount of the tip end of the cutter 42B shown in FIG. 4 was changed in the four steps from 0.20 to 0.5 mm, the inclined angle θ1 was changed in the six steps from 2.0 to 25 degrees, and the cut edge state of the web and the blade breakage were visually evaluated. The web butt-joining test was repeated 10 times under the same condition. The result is shown in the table in FIG. 13. In the table, β is the value of cos⁻¹(R/(R+H1)).

According to the table in FIG. 13, in the condition of the inclined angle θ1 in the range of 20 degrees≧θ≧1≧β, the cut edge states of the webs were all favorable, blade breakage was favorable (no breakage), and the judgment was OK for all. On the other hand, with the inclined angle θ1 of less than the above described range, the cut edge state of the web was unfavorable, and with the inclined angle θ1 exceeding the above range, blade breakage occurred, and judgment was NG for both of them.

What is claimed is:

1. A web butt-joining apparatus, comprising:
a turret device that supports an old roll and a new roll on which band-shaped flexible base materials are wound to be capable of being unwound, and is rotatable at every predetermined angle;
a cutting drum including a cutting member, which is provided at a cylindrical portion of a peripheral surface with its tip end protruded, forms an inclined angle of 0.5 degrees to 5 degrees with respect to an axial direction of the cylindrical portion, and has substantially the same length as a width of the band-shaped flexible base material, and a holding device that holds a tip end portion of the band-shaped flexible base material of the new roll, and capable of rotating at the same speed as conveyance speed of the band-shaped flexible base material at a time of joining the band-shaped flexible base materials;
a cutting and joining drum which includes a cutting receiving member of substantially the same length as the width of the band-shaped flexible base material, and a holding device which holds a portion in the vicinity of a tail end portion of the band-shaped flexible base material of the old roll, and is capable of rotating at the same speed as a conveyance speed of the band-shaped flexible base material at a time of joining the band-shaped flexible base materials; and
a joining drum which holds a bonding tape to be separable and is capable of rotating at the same speed as the conveyance speed of the band-shaped flexible base material at a time of joining the band-shaped flexible base materials,
wherein while conveying the band-shaped flexible base material, the web butt-joining apparatus performs cutting and butt-joining of the tail end of the band-shaped flexible base material of the old roll and the tip end of the band-shaped flexible base material of the new roll.

2. A web butt-joining apparatus, comprising:
a turret device that supports an old roll and a new roll on which band-shaped flexible base materials are wound to be capable of being unwound, and is rotatable at every predetermined angle;
a cutting drum including a cutting member, which is provided at a cylindrical portion with a radius R of a peripheral surface with its tip end protruded with a protruded amount h, forms an inclined angle θ with respect to a radius direction of the cylindrical portion, and has substantially the same length as a width of the band-shaped flexible base material, a cushioning member composed of foaming rubber provided at both sides of the cutting member, and a holding device that holds a tip end portion of the band-shaped flexible base material of the new roll, with the inclined angle θ in the relationship of 20 degrees≧θ≧cos⁻¹(R/(R+h)), and capable of rotating at the same speed as conveyance speed of the band-shaped flexible base material at a time of joining the band-shaped flexible base materials;
a cutting and joining drum which includes a cutting receiving member of substantially the same length as the width of the band-shaped flexible base material, and a holding device which holds a portion in the vicinity of a tail end portion of the band-shaped flexible base material of the old roll, and is capable of rotating at the same speed as conveyance speed of the band-shaped flexible base material at a time of joining the band-shaped flexible base materials; and
a joining drum which holds a bonding tape to be separable and is capable of rotating at the same speed of the conveyance speed of the band-shaped flexible base material at a time of joining the band-shaped flexible base materials,
wherein while transferring the band-shaped flexible base material, the web butt-joining apparatus performs cutting and butt-joining of the tail end of the band-shaped flexible base material of the old roll and the tip end of the band-shaped flexible base material of the new roll.

3. A web butt-joining apparatus, comprising:
a turret device that supports an old roll and a new roll on which band-shaped flexible base materials are wound to be capable of being unwound, and is rotatable at every predetermined angle;
a cutting drum including a cutting member block, which is provided at a front surface of a block with its tip end protruded, with a cutting member of substantially the same length as the width of the band-shaped flexible base material embedded therein, a cylindrical portion having a peripheral surface capable of fitting the cutting member block in a recessed portion formed on a front surface to be flush with each other, and a holding device holding a tip end portion of the band-shaped flexible base material of the new roll, and capable of rotating at the same speed as conveyance speed of the band-shaped flexible base material at a time of joining the band-shaped flexible base materials;
a cutting and joining drum which includes a cutting receiving member of substantially the same length as the width of the band-shaped flexible base material, and a holding device which holds a portion in the vicinity of a tail end portion of the band-shaped flexible base material of the old roll, and is capable of rotating at the same speed as conveyance speed of the band-shaped flexible base material at a time -of joining the band-shaped flexible base materials; and
a joining drum which holds a bonding tape to be separable and is capable of rotating at the same speed as the conveyance speed of the band-shaped flexible base material at a time of joining the band-shaped flexible base materials, wherein while transferring the band-shaped flexible base material, the web
butt-joining apparatus performs cutting and butt-joining of the tail end of the band-shaped flexible base material of the old roll and the tip end of the band-shaped flexible base material of the new roll.

4. The web butt-joining apparatus according to claim 1, wherein
Vickers hardness of the cutting receiving member is 1000 or more.

5. The web butt-joining apparatus according to claim 2 wherein
Vickers hardness of the cutting receiving member is 1000 or more.

6. The web butt-joining apparatus according to claim 3, wherein
Vickers hardness of the cutting receiving member is 1000 or more.

7. The web butt-joining apparatus according to claim 1, wherein
a metallizing plating layer of a thickness of 10 to 30 μm is formed on a front surface of the cutting receiving member.

8. The web butt-joining apparatus according to claim 2, wherein
a metallizing plating layer of a thickness of 10 to 30 μm is formed on a front surface of the cutting receiving member.

9. The web butt-joining apparatus according to claim 3, wherein
a metallizing plating layer of a thickness of 10 to 30 μm is formed on a front surface of the cutting receiving member.

10. The web butt-joining apparatus according to claim 4, wherein
a metallizing plating layer of a thickness of 10 to 30 μm is formed on a front surface of the cutting receiving member.

11. The web butt-joining apparatus according to claim 1, wherein
Vickers hardness of the cutting member is 600 to 1000.

12. The web butt-joining apparatus according to claim 2, wherein
Vickers hardness of the cutting member is 600 to 1000.

13. The web butt-joining apparatus according to claim 3, wherein
Vickers hardness of the cutting member is 600 to 1000.

14. The web butt-joining apparatus according to claim 4, wherein
Vickers hardness of the cutting member is 600 to 1000.

15. The web butt-joining apparatus according to claim 7, wherein
Vickers hardness of the cutting member is 600 to 1000.

16. A web butt-joining method for performing cutting and butt-joining of a tail end of a band-shaped flexible base material of an old roll and a tip end of a band-shaped flexible base material wound round a new roll while causing the band-shaped base material wound around the old roll to travel, comprising the steps of:
winding the band-shaped flexible base material of the new roll on a cutting drum, and holding a tip end portion of the band-shaped flexible base material of the new roll by a new web holding device of the cutting drum;
winding the band-shaped flexible base material of the old roll on a cutting and joining drum and holding a portion in the vicinity of a tail end portion of the band-shaped flexible base material of the old roll by an old web holding device of-the cutting and joining drum;
holding a bonding tape at a joining drum;
while rotating the cutting and joining drum at the same speed as conveyance speed of the band-shaped flexible base material, and rotating the cutting drum at the same speed as conveyance speed of the band-shaped flexible base material, cutting the band-shaped flexible base material of the old roll and the band-shaped flexible base material of the new roll in an overlapped state by a cutting member which is provided at a cylindrical portion of a peripheral surface of the cutting drum or the cutting and joining drum with its tip end protruded and which forms an inclined angle of 0.5 degrees to 5 degrees with respect to an axial direction of the cylindrical portion;
casting away a portion in the vicinity of the tail end portion of the band-shaped flexible base material of the old roll and the tip end portion of the band-shaped flexible base material of the new roll which are cut, and holding the band-shaped flexible base material of the old roll and the band-shaped flexible base material of the new roll on the peripheral surface of the cutting drum or the cutting and joining drum; and
bonding the bonding tape held at the joining drum to the band-shaped flexible base material of the old roll and the band-shaped flexible base material of the new roll held at the peripheral surface of the cutting drum or the cutting and joining drum.

17. A web butt-joining method for performing cutting and butt-joining of a tail end of a band-shaped flexible base material of an old roll and a tip end of a band-shaped flexible base material wound around a new roll while causing the band-shaped base material wound around the old roll, comprising the steps of:
winding the band-shaped flexible base material of the new roll on a cutting drum, and holding a tip end portion of the band-shaped flexible base material of the new roll by a new web holding device of the cutting drum;
winding the band-shaped flexible base material of the old roll on a cutting and joining drum and holding a portion in the vicinity of a tail end portion of the band-shaped flexible base material of the old roll by the old web holding device of the cutting and joining drum;
holding a bonding tape at a joining drum;
while rotating the cutting and joining drum at the same speed as conveyance speed of the band-shaped flexible base material, and rotating the cutting drum at the same speed as conveyance speed of the band-shaped flexible base material, cutting the band-shaped flexible base material of the old roll and the band-shaped flexible base material of the new roll in an overlapped state by a cutting member which is provided at a cylindrical portion with a radius R of a peripheral surface of the cutting drum or the cutting and joining-drum with its tip end protruded with a protruded amount h and which forms an inclined angle θ with respect to a radius direction of the cylindrical portion, which is a cutting member with the inclined angle θ being in relationship of 20 degrees≧θ≧cos⁻¹(R/(R+h)), and cushioning members composed of foaming rubber provided at both sides of the cutting member;
casting away a portion in the vicinity of the tail end portion of the band-shaped flexible base material of the old roll and the tip end portion of the band-shaped flexible base material of the new roll which are cut, and holding the band-shaped flexible base material of the old roll and the band-shaped flexible base material of the new roll on the peripheral surface of the cutting drum or the cutting and joining drum; and
bonding the bonding tape held at the joining drum to the band-shaped flexible base material of the old roll and the band-shaped flexible base material of the new roll held at the peripheral surface of the cutting drum or the cutting and joining drum.
